(19) United States
(12) Patent Application Publication
(10) Pub. No.: US 2009/0021386 A1
(43) Pub. Date: Jan. 22, 2009

(54) CUSHION DEVICE WITH MULTIPLE FUNCTIONS

(76) Inventor: CHUAN-CHENG LIAO, Hsinchuang City (TW)

Correspondence Address: LEONG C LEI, PMB # 1008, 1867 YGNACIO VALLEY ROAD, WALNUT CREEK, CA, 94598, US

(21) Appl. No.: 12/171,305

(22) Filed: Jul. 11, 2008

(30) Foreign Application Priority Data
Jul. 19, 2007 (TW) 096211757

(51) Int. Cl. G08B 21/00

(52) U.S. Cl. 340/667

(57) ABSTRACT

The cushion device mainly contains a flat body member containing a pad on top of a base. The base has an indentation on a top side for accommodating a pressure activation member. The pressure activation member contains a first disc resiliently supported on a top side of a second disc by a number of resilient elements. A number of sensitive switches are also provided on the top side of the second disc. The switches turn on a timing element by the descent first disc and then turn the timing element off when the first disc is restored to its original position by the resilient elements. A number of reminding elements such as a vibrator, a sound generator, and a light generator are connected to and commanded by the timing element to produce vibrations, sounds or voices, or lighting after a preset period of time.

### (a) TECHNICAL FIELD OF THE INVENTION

The present invention generally relates to cushions for sitting or lying, and more particularly to a cushion device capable of automatically providing vibrating, audible, or visual reminder after a period of usage.

### (b) DESCRIPTION OF THE PRIOR ART

Lacking exercise is a common problem to modern people as they spend too much time sitting in front of a desk, computer, or television. Significant weight gaining is the most common consequence.

Most people do realize the impact of sitting too long on their health. However, they are often too occupied with the job they are working on, the game they are playing, or the TV program they are watching. If a cushion capable of automatically reminding its sitter to get out of seat after it is being sit on for a period of time, this would be very helpful.

There are quite a few teachings about seat cushions such as Republic of China, Taiwan, Patent Nos. M249565, M266796, M267934, M273268, M288553, M295972, M297733, M300535, 97805, 285870, 287421, 372192, 391395, 457888, 463638, 478465, 481988, 517584, 525483, 541952, 576190. However, none of these discloses a cushion device having built-in timer and audio or visual alarm to perform the aforementioned automatic reminding function.

### SUMMARY OF THE INVENTION

It is the object of the present invention to provide a novel cushion device capable of automatically reminding the person sitting or lying on the cushion device to get up after a period of time is provided herein.

The cushion device mainly contains a flat body member containing a pad on top of a base. The base has an indentation on a top side for accommodating a pressure activation member The pressure activation member contains a first disc resiliently supported on a top side of a second disc by a number of resilient elements. A number of sensitive switches are also provided on the top side of the second disc. The switches turn on a timing element by the descent first disc and then turn the timing element off when the first disc is restored to its original position by the resilient elements. A number of reminding elements such as a vibrator, a sound generator, and a light generator are connected to and commanded by the timing element to produce vibrations, sounds or voices, or lighting after a preset period of time.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a cushion device according to an embodiment of the present invention when it is assembled.

FIG. 2 is an exploded diagram showing the various components of the cushion device of FIG. 1.

FIG. 3 is a sectional diagram showing the cushion device of FIG. 1.

FIG. 4 shows an application scenario of the cushion device of FIG. 1 when a person sits on the cushion device.

FIG. 5 shows an application scenario of the cushion device of FIG. 1 when one or more reminders are produced.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

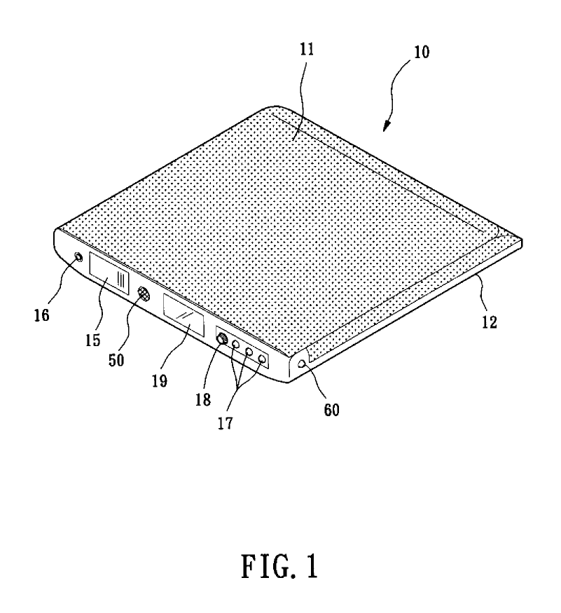

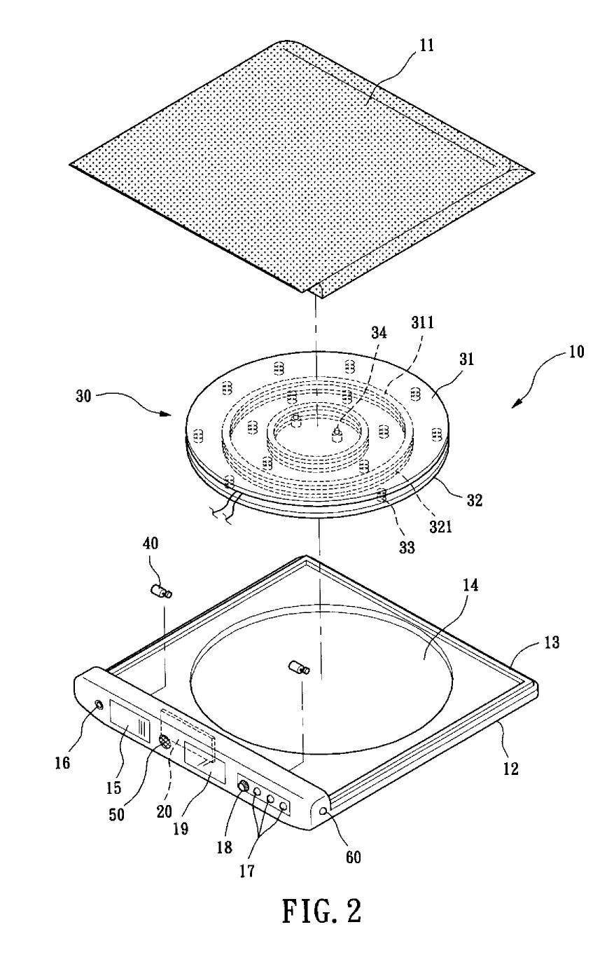

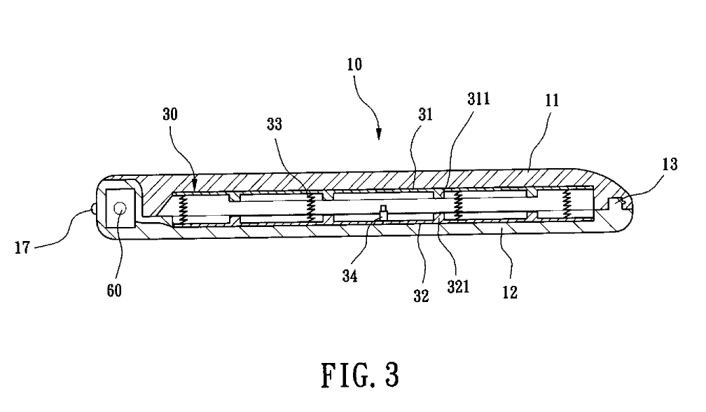

As shown in FIGS. 1, 2, and 3, a cushion device according to an embodiment of the present invention mainly contains a flat body member 10 which could be sit on or lied on. Inside the body member 10, there is a timing element 20, a pressure activation member 30, and a number of reminding elements such as a vibrator 40, a sound generator 50, a light generator 60, etc. When a person sits or lies on the body member 10, the pressure activation member 30 activates the timing element 20 so that the timing element 20 would make the reminding elements to produce vibrations, sounds or voices, or lighting automatically after a period of time. The person therefore would be reminded and get up for some exercise.

The body member 10 contains a pad 11 on top of a base 12. The pad 11 has an appropriate softness for seating comfort. It is also the pad 11 that receive a person's weight and trigger the pressure activation member 30.

The base 12 has an enclosed flange 13 on a top side of the base 12 for joining with the pad 11. Also on the top side of the base 12 and within the flange 13, there is an indentation 14 for accommodating the pressure activation member 30. A power supply element 15 is also housed at an appropriate place inside the base 12. The power supply element 15 could contain a battery (not shown) or a connector 16 for connecting to an external power source (also not shown). Along a side wall of the base 12, there are a number of selection buttons 17 and a time adjustment button 18. These buttons are for the selection of the types of reminding and the length of time after which the reminder is issued. In some alternative embodiment, these buttons are sealed or protected to prevent them from accidental trigger. Also on the side wall, there is a display panel 19 for showing the current status and configuration of the cushion device.

The timing element 20 mainly contains a circuit board housed at an appropriate place inside the base 12. The circuit board contains a timing circuit. Instead of using electronic components, the timing element 20 could also be implemented using a mechanical or other appropriate timing mechanism.

The pressure activation member 30 contains a first disc 31 stacked on a top side of a second disc 32. A number of resilient elements 33 are distributed on the top side of the second disc 32 so that the first disc 31 is resiliently supported by the second disc 32. A ring flange 321 is provided on the top side of the second disc 32 and, correspondingly, another ring flange 311 is provided on a bottom side of the first disc 31 that interfaces with the second disc 32. The ring flanges 311 and 321 prevent the first disc 31 from descending too much by the pad 11. A number of sensitive switches 34 are also provided on the top side of the second disc 32. These switches 34 are toggle switches or other similar switches. The switches 34 are connected to the timing element 20 by conductor wires. The switches 34 turns on (i.e., allows electricity to pass to) the timing element 20 by the descent first disc 31 and then turns the timing element 20 off (i.e., disallows electricity to pass through) when the first disc 31 is restored to its original position by the resilient elements 33.

A vibrator 40 is housed at an appropriate place inside the body member 10. The vibrator 40 is connected to the timing element 20 and commanded by the timing element 20 to or not to produce continuous or intermittent vibrations. The vibrator 40 could be a motor driving an eccentric block or other similar vibrating mechanism.

A sound generator 50 is housed at an appropriate place inside the body member 10. The sound generator 50 is connected to the timing element 20 and commanded by the timing element 20 to or not to play a pre-recorded voice or musical segment. The sound generator 50 could contain an audio chip (such as one used in a musical greeting card) or a simple buzzer or other similar sound producing mechanism.

A light generator 60 is housed at an appropriate place inside the body member 10. The light generator 60 is connected to the timing element 20 and commanded by the timing element 20 to or not to produce lightings. The light generator 60 could contain a light bulb, a light emitting diode, a fiber, or a light guide, or other similar light producing mechanism.

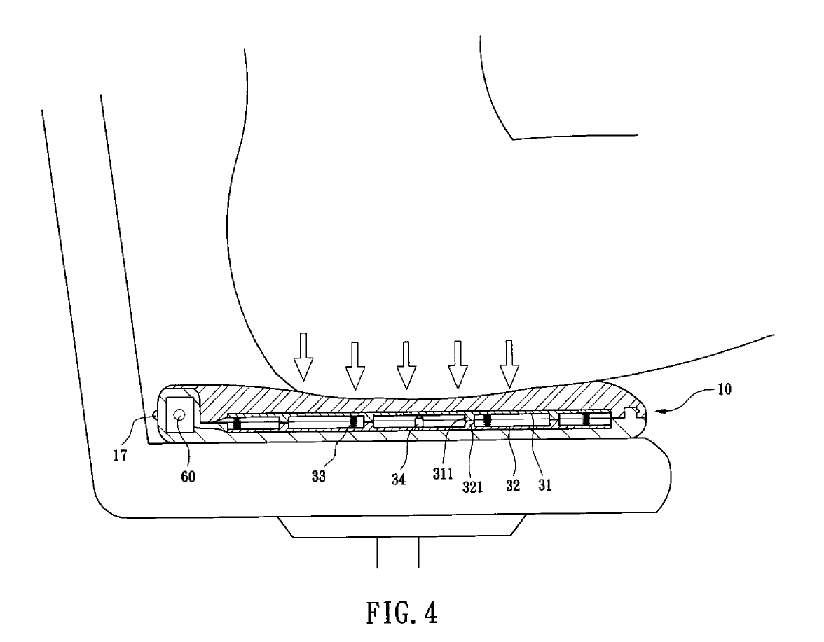

As shown in FIG. 4, when a person sits or lies on the pad 11 of the body member 10, the person's weight press the first disc 31 downward until the ring flanges 311 and 321 touch each other. The sensitive switches 34 thereby turns on the timing circuit of the timing element 20 to start counting time.

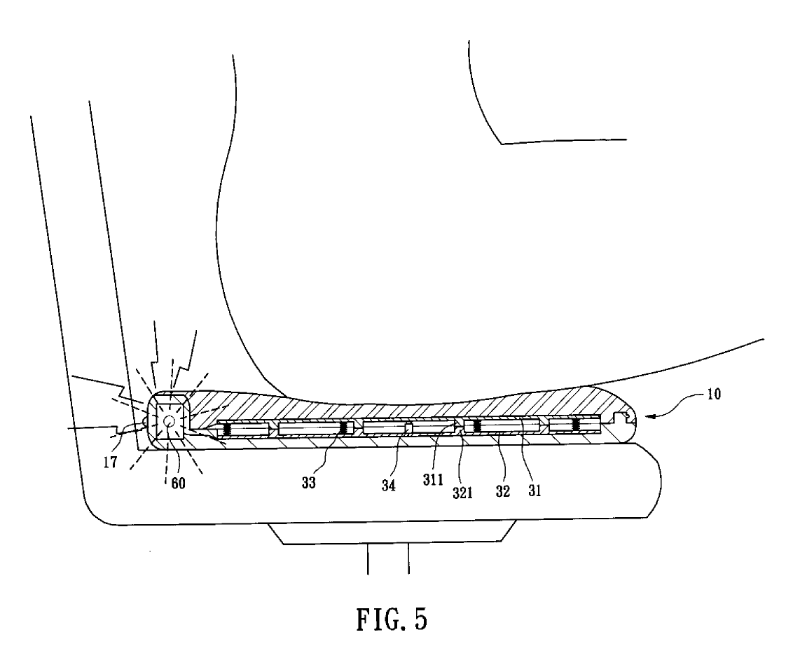

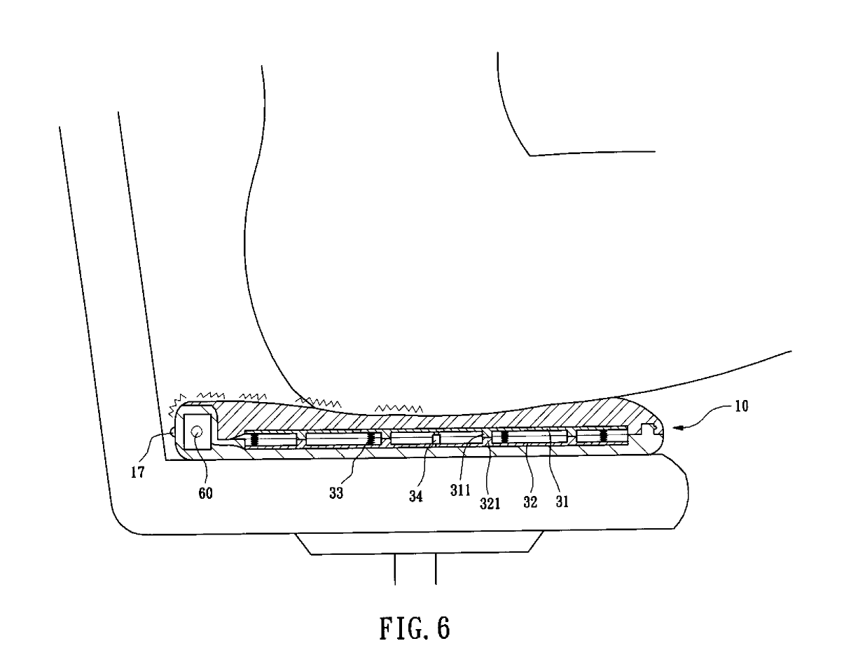

As shown in FIGS. 5 and 6, when the preset period of time has elapsed, the timing element 20 activates the vibrator 40, the sound generator 50, and the light generator 60 to produce vibration, audible sounds, or lighting to remind the person. By using the selection buttons 17, a person could pre-configure the cushion device to produce only one of the reminders or a combination of two or more reminders.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cushion device, comprising:
a body member having a portion to receive weight;
a timing element housed inside said body member capable of counting time when turned on;
a pressure activation member housed inside said body member, said pressure activation member having at least a sensitive switch, and at least a resilient element supporting said portion of said body member; and
at least a reminding element housed inside said body member, said reminding element connected to said timing element capable of producing a reminding signal.

2. The cushion device according to claim 1, wherein said portion of said body member is a pad having an appropriate softness and transferring weight to said pressure activation member.

3. The cushion device according to claim 1, wherein said body member has at least a flange which will provide an engaging function when said body member is pressed to deform.

4. The cushion device according to claim 1, wherein said sensitive switch is a switch that allows electricity to pass through under a pressure.

5. The cushion device according to claim 1, wherein said sensitive switch is a toggle switch.

6. The cushion device according to claim 1, wherein said reminding element is a vibrator.

7. The cushion device according to claim 1, wherein said reminding element is a sound generator.

8. The cushion device according to claim 1, wherein said reminding element is a light generator.

9. The cushion device according to claim 1, wherein said timing element is a circuit board with a timing circuit.

10. The cushion device according to claim 1, wherein said timing element is a mechanical means.
